(19) United States
(12) Patent Application Publication
(10) Pub. No.: US 2021/0153305 A1
(43) Pub. Date: May 20, 2021

(54) HEATING MODULE

(71) Applicant: Mahle International GmbH, Stuttgart (DE)

(72) Inventors: Stefan Boegershausen, Stuttgart (DE); Marcel Huelss, Stuttgart (DE); Falk Viehrig, Stuttgart (DE); Robin Wanke, Stuttgart (DE)

(21) Appl. No.: 16/950,854

(22) Filed: Nov. 17, 2020

(30) Foreign Application Priority Data
Nov. 18, 2019 (DE) 102019217693.3

(51) Int. Cl. H05B 3/14; H05B 3/16; H05B 3/00

(52) U.S. Cl. CPC H05B 3/141; H05B 3/16; H05B 2203/019; H05B 2203/02; H05B 3/0042

(57) ABSTRACT

A heating module includes at least one cold conductor element and at least one electrical heating element that is different from the at least one cold conductor element. The at least one cold conductor element and the at least one heating element are electrically connectable in parallel. The at least one cold conductor element and the at least one heating element are connected with one another thermally in a heat-transferring manner.

### CROSS-REFERENCE TO RELATED APPLICATION

This application claims priority to German Application No. DE 10 2019 217 693.3 filed Nov. 18, 2019, the contents of which are hereby incorporated by reference in its entirety.

### TECHNICAL FIELD

The present invention relates to a heating module with at least one cold conductor element and with at least one electrical heating element, which is different from a cold conductor element. The invention further relates to a heating device with such a heating module and with a control device for operating the heating device.

### BACKGROUND

Cold conductor elements, also designated Positive Temperature Coefficient Element or abbreviated as PTC elements, are coming into use increasingly in heating modules for heating a fluid or an object. This is due in particular to the electrical resistance, increasing with increasing temperature, of cold conductor elements, which, in particular in the case of a constantly applied electrical voltage, results in a maximum temperature of the cold conductor element.

In operation, such a cold conductor element generally firstly runs through a Negative Temperature Coefficient Range, hereinbelow also abbreviated as NTC range. In the NTC range, the electrical resistance of the cold conductor element firstly decreases with increasing temperature, until at a starting temperature of the cold conductor element a minimum electrical resistance of the cold conductor element is reached. Starting from this minimum electrical resistance, the electrical resistance increases with increasing temperature, so that the cold conductor element is operated in the PTC range. In the NTC range therefore firstly, in particular in the case of a constantly applied electrical voltage, the electrical current through the cold conductor element increases, in order, with increasing temperature, to subsequently fall in the PTC range. The transition between the NTC range and the PTC range is also designated the switching point of the cold conductor element. At the transition and in the switching point, peaks occur in the electrical current and in the electrical voltage, in particular due to the given capacities and inductivities. These peaks can lead to damage in the heating module and/or in further components which are electrically connected to the heating module. Consequently, both the heating module and also said components are designed in such a way that they withstand said current peaks and voltage peaks. This leads to an increased effort and increased costs in the production of the heating module and/or of said components.

Such heating modules are used in particular in motor vehicles. The heating module can be operated here with the supply voltage of the motor vehicle, which lies for example in the region of 12 V. In an increasing number of motor vehicles, in particular at least partially electrically operated motor vehicles, therefore for example in hybrid vehicles and/or e-vehicles, electric vehicles, electrical voltages are present which are many times higher. These voltages usually lie above 100 V, in particular at several 100 V, for example between 300 V and 1000 V, in particular between 400 V and 800 V. It is expedient here to operate the heating module and in particular the cold conductor element with the higher voltages, in order for example to increase the output of the heating module and/or to simplify the integration of the heating module into the motor vehicle.

However, the increased electrical voltage leads to current peaks and/or voltage peaks, which are described above, occurring in an intensified manner and being able to lead to intensified damage to the heating module or respectively components electrically connected to the heating module. A design of the heating module and of the said components for preventing the damage therefore becomes more laborious and more expensive.

Such heating modules are usually designed for the provision of a maximum heating capacity, which is predetermined. The maximum heating capacity is usually selected in such a way that the heating module also provides heat or respectively heating conducting sufficiently. These maximum requirements lead to a corresponding design of the cold conductor elements of the heating module, which in turn lead to an increase of the previously described current peaks and/or voltage peaks. This also leads to a laborious and expensive production of the heating module and of the components which are electrically connected to the heating module.

The occurring current peaks and voltage peaks lead, in addition, to an increased expenditure in the operating of the heating module.

In order to reduce such current peaks, it is proposed in DE 10 2017 218899 A1 to provide several heating stages, connected in parallel, in a heating device, wherein in the respective heating stage a cold conductor element and an inductive heating element are connected in series. With the inductive heating element, a reduction of the capacitive inrush current takes place of the cold conductor element which is connected in series with the inductive heating element, so that the capacitively caused current peaks are reduced.

In the heating device known from the prior art, current peaks nevertheless occur, in particular with increased operating voltage, which make the production and the operation of the heating device expensive and laborious.

The present invention is therefore concerned with the problem of indicating, for a heating module of the above-mentioned type and for a heating device with such a heating module, improved or at least different embodiments which in particular are distinguished by a simplified and/or favourably priced production and/or by a simplified operation.

This problem is solved according to the invention by the subjects of the independent claims. Advantageous embodiments are the subject of the dependent claims.

### SUMMARY

The present invention is based on the general idea, in a heating module which has a cold conductor element and an electric heating element which is different from the cold conductor element, to connect the heating element and the cold conductor element with one another in a heat-transferring manner and to connect them electrically in parallel. The thermal connection between the heating element and the cold conductor element is such that with the heating element, the Negative Temperature Coefficient range, also abbreviated below as NTC range, of the cold conductor element is overcome, so that the cold conductor element in operation firstly is heated with the heating element, in order to reach a temperature which is equal to or higher than a starting temperature of the cold conductor element, at which the cold conductor element has a minimum electrical resistance. In this way, it is therefore prevented that the cold conductor element in operation, at the transition between the NTC range and the range in which the electrical resistance increases with increasing temperature, i.e. the Positive Temperature Coefficient range, also designated below as PTC range, generates electrical current peaks and/or voltage peaks. This leads to the heating module being able to be produced in a simplified manner and/or at a more favourable cost, through the electric loads occurring in a reduced manner. In addition, in this way the heating module can be operated in a simplified manner. The electrical parallel connection of the cold conductor element with the heating element permits, furthermore, separating the cold conductor element entirely from the electric supply up to reaching the starting temperature, so that the cold conductor element does not generate its own heat for bridging the NTC range, and in particular is heated exclusively by the heating element. Therefore, it is possible to entirely prevent the occurrence of said current peaks and/or voltage peaks. This leads, in turn, to reduced damage to the heating module or respectively to components which are electrically connected to the heating module, and/or to a simplified operation and a more favourably priced production of the heating module. Alternatively or additionally, the electrical supply of the heating element can be optionally increased or reduced or respectively disconnected, in order for example to heat the cold conductor element in a desired manner and/or to operate a heating output of the heating module on reaching or respectively exceeding the starting temperature of the cold conductor element with reduced heating output through the heating element. As a whole, the operation of the heating module is thus therefore further simplified.

According to the idea of the invention, the heating module has the cold conductor element and the electric heating element, which is different from a cold conductor element. The cold conductor element, also designated Positive Temperature Coefficient element or abbreviated as PTC element, and the heating element are connected with one another here in a thermally heat-transferring manner, and are electrically connected in parallel, or able to be connected in parallel, in the heating module.

The heat-transferring connection between the heating element and the cold conductor element is expediently such that the temperature of the cold conductor element corresponds substantially to the temperature of the heating element. Substantially means here in particular that the aligning of the temperatures of the cold conductor element and of the heating element due to the heat transfer does not take place instantaneously.

The cold conductor element has in particular a characteristic and temperature-dependent curve of the electrical resistance, shown by way of example in FIG. 1. Accordingly, the electrical resistance falls firstly with increasing temperature, until the electrical resistance reaches a minimum value at the starting temperature. The temperature range up to the starting temperature or respectively the associated decreasing electrical resistance are designated as NTC range. With increasing temperature, the electrical resistance rises, so that the range above the starting temperature is regarded as PTC range. When the temperature rises further, proceeding from the starting temperature, then the electrical resistance increases up to a nominal temperature, in which the cold conductor element has a nominal resistance. Above the nominal resistance, the electrical resistance rises more slowly. At an end temperature of the cold conductor element, the rise of the electrical resistance of the cold conductor element increases proceeding from an electrical end resistance belonging to the end temperature with distinct reduction. The range between the starting temperature and the end temperature is considered here as the working range of the cold conductor element.

The heating element, which is different from a cold conductor element, means in the present case in particular that the heating element does not have the characterizing resistance curve for a cold conductor element through the NTC range and the PTC range. In particular, the heating element is free of cold conductors or respectively free of a cold conductor element.

The heating element is, for example, a resistance heater, a heating wire, a thick film heater and suchlike.

The solution according to the invention allows the heating module to be provided in different shapes and/or sizes. The heating module can be formed in particular in the shape of a rod, therefore in particular as a heating rod.

In preferred embodiments, the cold conductor element is configured in such a way that a predetermined maximum operating temperature of the heating module lies above the starting temperature of the cold conductor element. It is therefore possible to use the cold conductor element, in particular as soon as the starting temperature of the cold conductor element is reached, for providing the heating output of the heating module.

It is advantageous if the cold conductor element is configured in such a way that the maximum operating temperature is at least equal to the nominal temperature, preferably greater than the nominal temperature, of the cold conductor element. Therefore, it is possible to use the cold conductor element in a greater temperature range for the providing of the heating output of the heating module.

Preferred embodiments make provision that the predetermined maximum operating temperature of the heating module is equal to or greater than the end temperature of the cold conductor element. This makes it possible to use the cold conductor element in a greater temperature range for the providing of the heating output of the heating module. In addition, it is therefore possible to supply the heating element electrically if required additionally to the heating element, in order to provide the difference between the heating output of the cold conductor element and the required heating output of the heating module.

Embodiments are considered advantageous, in which the electrical resistance of the heating element and a nominal resistance of the cold conductor element are in a ratio of between 95:5 to 5:95. Therefore it is possible, for example, in particular on reaching the starting temperature of the cold conductor element, to provide the heating output of the heating module, also designated below as total heating output, exclusively or at least predominantly through the cold conductor element. Ratios between the electrical resistance of the heating element and the nominal resistance of between 30:70 to 70:30 are particularly preferred here.

The heat-transferring connection between the cold conductor element and the heating element can basically be configured as desired. In particular, the heat-transferring connection between the cold conductor element and the heating element is implemented by different means from a simple electrical connection, for example through a cable, a litz wire and suchlike, and/or a pure convection and/or a pure thermal radiation.

The heating module can have a body which is separate from the cold conductor element and from the heating element for heat transmission between the heating element and the cold conductor element, also designated below as heat transfer body.

The heat exchanger is preferably connected in a planar manner with the cold conductor element and with the heating element, in order to therefore connect these thermally with one another in a heat-transferring manner. In particular, it is conceivable that the heat transfer body lies in a planar manner against the cold conductor element and against the heating element.

The heat transfer element can basically have any desired shape and/or extent.

Of course, the heating module can also have two or more heat transfer bodies.

Embodiments are also conceivable in which at least one of the heat transfer bodies is configured as a plate. Therefore, it is possible to produce the heating module in a manner which saves installation space and, at the same time with a high heat transfer between the cold conductor element and the heating element. In particular, it is therefore possible to arrange the cold conductor element and the heating element between two such plates.

Alternatively or additionally, it is conceivable that at least one of the heat transfer bodies is formed as a ceramic. In particular, it is conceivable that at least one of the at least one heat transfer bodies is a ceramic plate. Therefore, in addition to an advantageous heat-transferring connection between the cold conductor element and the heating element, an electrical insulation of the heating module, in particular toward the exterior and/or between the heating element and the cold conductor element, is achieved.

Alternatively or additionally, it is conceivable to integrate the cold conductor element and the heating element in at least one such ceramic plate, in such a way that the cold conductor module and the heating module are received in the ceramic plate.

Likewise, it is conceivable to provide a ceramic body as heat transfer body, in which the cold conductor element and the heating element are embedded.

It is conceivable to arrange the cold conductor element and the heating element adjacent to one another in a direction of the heating module, also designated below as neighbour direction, and to arrange such a plate in a direction running transversely to the neighbour direction, which is arranged adjacent to the cold conductor element and the heating element. The plate is preferably electrically insulating, in order to insulate the cold conductor element and the heating element electrically toward the exterior. The plate can be in particular said ceramic plate.

The heating module is usually designed to a maximum total heating output, wherein the total heating output of the heating module can be predetermined depending on the use of the heating module.

Embodiments are preferred, in which the cold conductor element is configured, in particular through a corresponding formation and/or dimensioning, in such a way that a maximum heating output of the cold conductor element, also designated below as cold conductor heating output, corresponds to between 80% and 95% of the maximum total heating output. In addition, the heating element is configured in such a way that a maximum heating output of the heating element, also designated below as heating element heating output, corresponds at least to the difference between the maximum total heating output and the maximum cold conductor heating output, so that the heating element can provide the difference between the maximum total heating output and the maximum cold conductor heating output. Therefore, it is possible to operate the heating element after the bridging of the NTC range only in the case of output peaks which exceed the maximum cold conductor heating output, and to provide the required total heating output otherwise through the cold conductor element. Here, use is made of the knowledge that such heating modules are also designed for output peaks, otherwise and predominantly, however, to provide heating outputs which lie below the maximum total heating output. In this way, it is possible to produce the heating module at a more favourable cost and more simply, and to operate it more easily. In particular, it is therefore possible to configure the cold conductor element accordingly, so that current peaks and/or voltage peaks described above, due to the reduced configuration of the cold conductor element occur to a reduced extent.

The heating module can basically be used for heating any desired fluid and/or any desired object.

For this purpose, the heating module is usually a component part of a heating device. It shall be understood here that a heating device with such a heating module also belongs to the scope of this invention.

The heating device comprises advantageously in addition to the heating module a switching device, which is configured in such a way that in operation it respectively optionally produces and disconnects the electrical supply of the cold conductor element and of the heating element. Configurations are also included here in which the electrical supply can be varied respectively. The heating device further comprises a determining device, which is configured in such a way that in operation it determines at least one value characterizing the temperature at least of one of the elements, i.e. of the cold conductor element and/or of the heating element. The heating device has, furthermore, a control device which is connected with the switching device and the determining device in a communicating manner and is configured for operating the heating device. Therefore, it is possible to supply electrically the respective element, i.e. the cold conductor element and the heating element, depending on the at least one determined value characterizing the temperature.

In preferred embodiments, operation is carried out in a starting operation when the temperature of the cold conductor element lies below the starting temperature of the cold conductor element. The temperature of the cold conductor element is determined and/or monitored here by means of the determining device through the determining at least of one of the at least one values. In the starting operation, the heating element is supplied electrically, whereas the electrical supply of the cold conductor element is interrupted. Therefore, the heating element generates heat, whereas the cold conductor element does not generate any heat. The starting operation is maintained until the cold conductor element reaches a temperature which corresponds at least to the starting temperature of the cold conductor element. This means that the cold conductor element is supplied electrically when the at least one value corresponds to a temperature of the cold conductor element which is equal to or greater than the starting temperature of the cold conductor element. In particular, the cold conductor element is supplied electrically when the at least one value corresponds to a temperature of the cold conductor element which lies between the starting temperature and the nominal temperature of the cold conductor element. Therefore, the cold conductor element is thus heated through the thermally heat-transferring connection with the heating element in the starting operation through the heating element, until it reaches at least the starting temperature. Consequently, the characteristic electrical behaviour of the cold conductor element is bridged or respectively jumped over in the NTC range and/or in the transition range between the NTC range and the PTC range. Consequently, the current peaks and/or voltage peaks occurring in this range do not occur, so that the heating device and the heating module are produced at a more favourable cost and more simply and/or can be operated in a simplified manner.

With the electrical supplying of the cold conductor element, a regular operation of the heating module preferably begins.

In the regular operation, expediently the at least one value is monitored.

In a variant of the regular operation, also designated below as first regular operation, the heating element still supplied electrically. When the heating module reaches a predetermined maximum operating temperature of the heating module, in particular at least one of the values corresponds to the maximum operating temperature of the heating module, the electrical output which is fed to the heating element is reduced here, in order to reduce the total heating output of the heating module and therefore the temperature of the heating module. This means in particular that in this case the cold conductor element is still constantly supplied electrically and the adaptation of the temperature takes place through a reduction of the output of the heating element. The reducing of the electrical output which is fed to the heating element can also comprise here an interruption of the fed electrical output. The maximum operating temperature of the heating device can correspond, furthermore, to the end temperature of the cold conductor element.

In a further variant, in the starting operation or respectively with the beginning of a variant of the regular operation, the electrical supply of the heating element can be interrupted. Therefore, the heating element is thus used for reaching and/or exceeding the starting temperature of the cold conductor element and is subsequently deactivated, in order to generate heat with the cold conductor element and therefore to provide the required total heating output with the cold conductor element.

Alternatively or additionally, it is possible to operate the heating module in a second regular operation. In the second regular operation, the required total heating output is provided to the heating module exclusively with the cold conductor element until the required total heating output reaches or respectively exceeds the maximum cold conductor heating output. On exceeding the required total heating output above the maximum cold conductor heating output, in addition the heating element is electrically supplied, in order to provide the difference between the required total heating output and the maximum cold conductor heating output. This leads to the heating device or respectively the heating module providing the required total heating output with the cold conductor element until the cold conductor element can no longer deliver this output. Only subsequently is the heating element used again. With a corresponding selection of the maximum cold conductor heating output, it is therefore possible to provide the required total heating output with the cold conductor element in the predominant cases, and to switch on the heating element when the heating output of the cold conductor element is insufficient. In particular a heating module of the type described above comes into use here in which the maximum cold conductor heating output corresponds to between 80% and 95% of the maximum total heating output. Therefore, the costs in the production and in the operation of the heating module or respectively of the heating element can be considerably reduced. In addition, in this way the heating module and the heating device can be operated in a simplified and energy-efficient manner.

The at least one value determined with the determining device can basically be any desired value, in so far as the value is one which is in a characteristic correlation with the temperature at least of one of the elements.

Basically, it is sufficient here to determine a single value which characterizes the temperature of one of the elements, wherein the thermally heat-transferring connection between the cold conductor element and the heating element leads to the temperature of the other element corresponding substantially to the temperature of the element, the temperature of which characterizes the value.

It is conceivable for this purpose to determine directly the temperature at least of one of the elements as such a value. Accordingly, the determining device is configured for determining the temperature at least of one of the elements. For example, the determining device is a temperature sensor or has at least one temperature sensor.

Alternatively or additionally, the determining device can be configured in such a way that it determines as one of the at least one values the electrical resistance of the cold conductor element. Here, the knowledge is utilized that the electrical resistance of the cold conductor element is associated with the temperature of the cold conductor element.

It is also conceivable, alternatively or additionally to determine as one of the at least one values a heating output of the heating module. Here, the knowledge is taken into consideration that the electrical resistance of the cold conductor element rises with increasing temperature so that, with a constantly applied electrical voltage, the cold conductor heating output provided by the cold conductor element is reduced with increasing temperature, so that the total heating output of the heating module is reduced.

When the heating device is used for heating a fluid, expediently a flow path of the fluid then leads through the heating device. The heating module is connected here with the flow path in a heat-transferring manner, so that the heating module in operation, i.e. with flowing of the fluid via the flow path, heats the fluid. Here, the heating module can be arranged in the flow path of the fluid.

It shall be understood that the heating module can also have two or more heating elements, which are respectively different from a cold conductor element. Likewise, it is conceivable that he heating module has two or more cold conductor elements which can differ from one another. Here, at least one heating element and at least one cold conductor element are connected with one another in a heat-transmitting manner and are electrically connected in parallel. Particularly preferably, all of the at least one cold conductor elements and the at least one cold conductor elements are electrically connected in parallel and are connected with one another in a heat-transferring manner.

The heating device can have two or more such heating modules, which are respectively connected in a heat-transferring manner with the flow path, in particular are arranged in the flow path.

It is conceivable to arrange between two such heating modules a structure which is able to be flowed through by the fluid, for example a grid and/or a rib structure. An enlargement of the heat-transferring area thus takes place. Consequently, a more efficient heating of the fluid takes place.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in closer detail in the following description, wherein the same reference numbers refer to identical or similar or functionally identical components.

### BRIEF DESCRIPTION OF THE DRAWINGS

There are shown, respectively schematically

FIG. 1 a characteristic curve of a cold conductor element.

FIG. 2 a first section through a heating module,

FIG. 3 a second section through the heating module,

FIG. 4 an equivalent circuit diagram of the heating module,

FIG. 5 an equivalent circuit diagram of a heating device with the heating module,

FIGS. 6 to 8 different sections through the heating module in another example embodiment,

FIGS. 9 to 11 different sections through the heating module in a further example embodiment,

FIG. 12 a highly simplified sectional view of the heating device,

FIG. 13 a section through the heating device in another example embodiment,

FIG. 14 the view of FIG. 13 in a further example embodiment.

### DETAILED DESCRIPTION

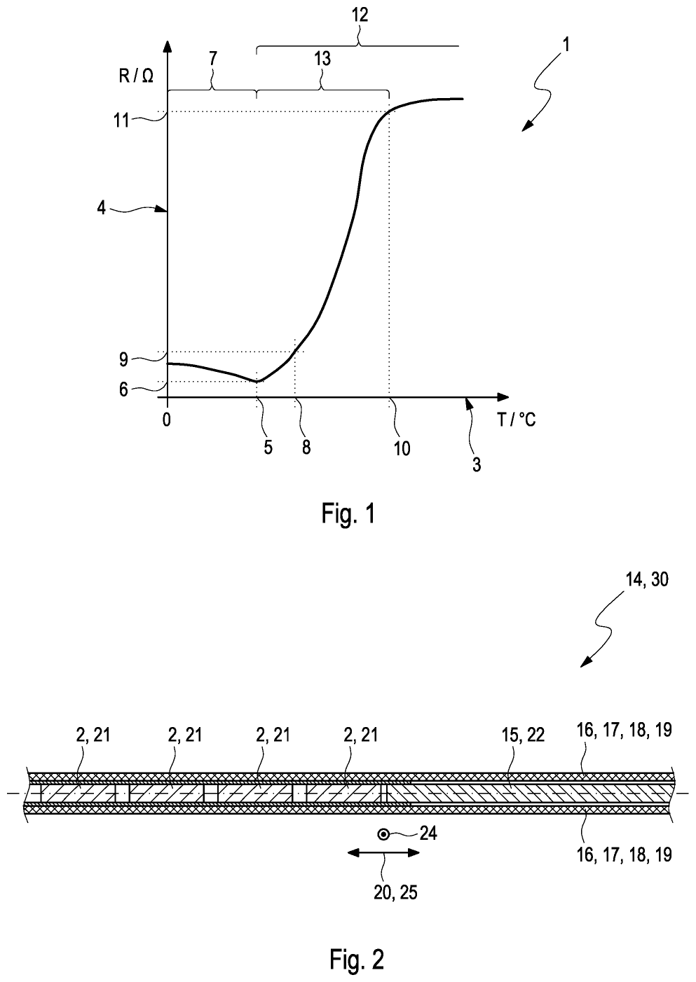

FIG. 1 shows a characteristic curve 1 of a cold conductor element 2, as is shown for example in FIGS. 2 to 14. The cold conductor element 2, also designated Positive Temperature Coefficient element 2 or abbreviated as PTC element 2, has according to FIG. 1 a temperature-dependent electrical resistance. Here in FIG. 1 the temperature is entered on the abscissa axis 3, and the electrical resistance is entered on the coordinate axis 4 on logarithmic scale. Accordingly, the electrical resistance of the cold conductor element 2 initially falls with increasing temperature, until at a starting temperature 5 a minimum resistance 6 of the cold conductor element 2 is reached. The temperature range up to the starting temperature 5 of the cold conductor 2 is designated as Negative Temperature Coefficient range 7, also abbreviated as NTC range 7 below. At temperatures above the starting temperature 5, the electrical resistance rises intensively up to a nominal temperature 8, at which the cold conductor element 2 has a nominal resistance 9. A less marked rise of the electrical resistance between the nominal temperature 8 and an end temperature 10, at which the cold conductor element 2 has an end resistance 11, follows the more intensive rise of the electrical resistance between the starting temperature 5 and the nominal temperature 8. Starting from the end temperature 10, the characteristic of the resistance changes, wherein the end temperature 10 or respectively the end resistance 11 forms a turning point of the curve 1. The range above the starting temperature 5 is designated here as Positive Temperature Coefficient range 12, also abbreviated below as PTC range 12. The temperature range between the starting temperature 5 and the end temperature 10 is regarded as working range 13 of the cold conductor element 2. The starting resistance 6 or respectively the starting temperature 5 are regarded as the switching point. This means that the resistance falls up to the turning point or respectively up to the starting temperature 5 or respectively, in so far as the cold conductor element 2 is connected to a voltage source, the electrical current increases through the cold conductor element 2, wherein owing to capacities and inductivities of the cold conductor element 2 in the switching point or respectively at the starting temperature 5 or the starting resistance 6, peaks occur in the electrical current and in the voltage.

A heating module 14 according to the invention, as is shown in FIGS. 2 to 7, prevents or reduces said current peaks and/or voltage peaks. For this purpose, the heating module 14 has, in addition to the cold conductor element 2, an electrical heating element 15 which is different from the cold conductor element 2. The heating element 15 therefore in particular does not show a characteristic curve for a cold conductor element 2, as is shown by way of example in FIG. 1. The heating element 15 is, in particular, free of a cold conductor element 2. The cold conductor element 2 and the heating element 15 are electrically connected in parallel here or are connected with one another in such a way that they are able to be electrically connected in parallel.

The cold conductor element 2 and the heating element 15 are connected with one another in a thermally heat-transferring manner, in such a way that the temperature of the cold conductor element 2 corresponds substantially to the temperature of the heating element 15. In the example embodiments which are shown, the heat-transferring connection of the cold conductor element 2 with the heating element 15 takes place via at least one heat transfer body 16 which is separate from the cold conductor element 2 and from the heating element 15. In the example embodiments which are shown, respectively two such heat transfer bodies 16 are provided, between which the heating element 15 and the cold conductor element 2 are arranged. The heat transfer bodies 16 which are shown are respectively formed in a plate-shaped manner or respectively as a plate 17. In addition, in the example embodiments which are shown, the heat transfer bodies 16 are electrically insulating. In particular, the heat transfer bodies 16 are formed as a ceramic 18, for example as a ceramic plate 19. The heat transfer bodies 16 therefore connect the cold conductor element 2 in a heat-transferring manner with the heating element 15 and electrically insulate the cold conductor element 2 and the heating element 15 toward the exterior. Here, in the examples which are shown, the cold conductor element 2 and the heating element 15 are arranged adjacent to one another in a direction 20, also designated below as neighbour direction 20, wherein the respective heat transfer body 16 is adjacent to the cold conductor element 2 and to the heating element 15 transversely to the neighbour direction 20. Here, in the example embodiments which are shown, the respective heat transfer body 16 lies in a planar manner against the cold conductor element 2 and against the heating element 15. In the example embodiments which are shown, the heating module 14 is therefore formed in the manner of a rod 30, also designated below as heating rod 30.

In the example embodiments which are shown, the respective cold conductor element 2 is parallelepiped-shaped and is formed in the manner of a block. In particular the respective cold conductor element 2 is formed as a so-called cold conductor block 21, also designated below as PTC block 21.

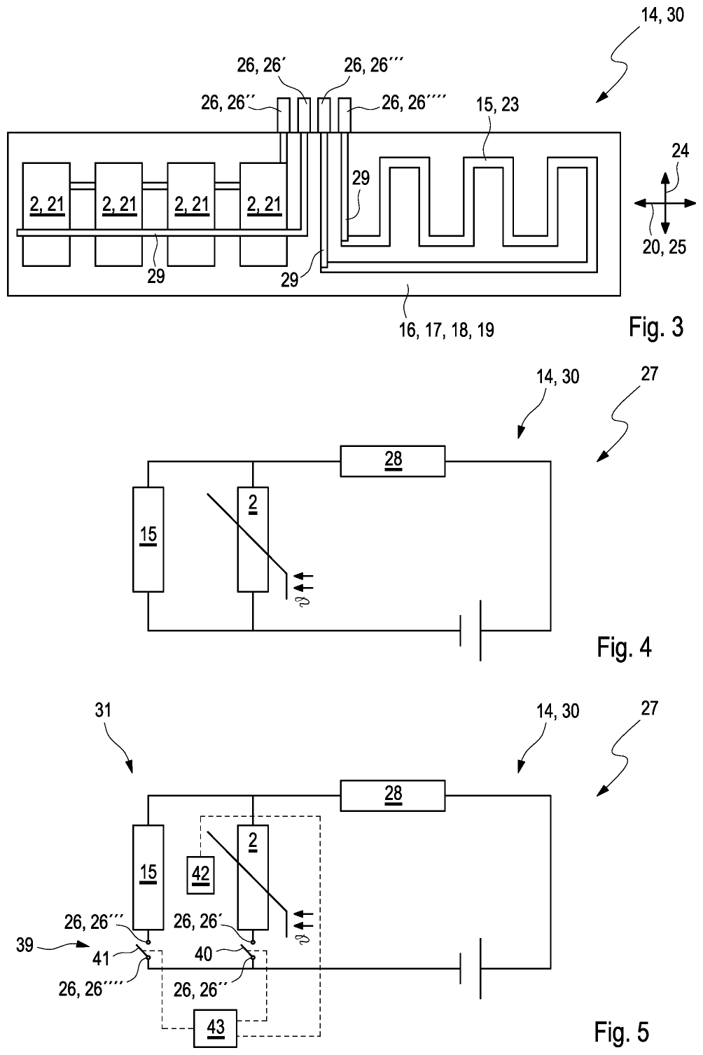

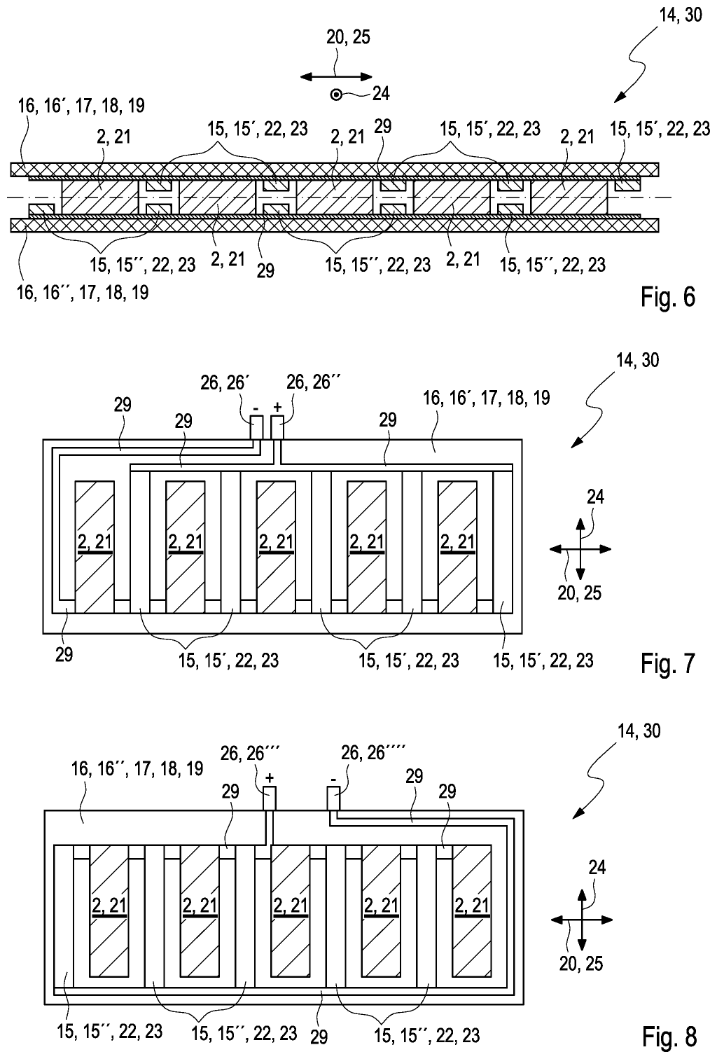

In the example embodiments of FIGS. 2 and 3, the respective heating element 15 is formed purely by way of example as a web-like resistance heater 23. However, the heating element 15 can also be formed as a thick film heater 22, as shown in the example embodiments of FIGS. 6 to 14.

The example embodiments of the heating module 14 which are shown provide respectively purely by way of example two or more cold conductor elements 2 per heating module 14.

FIGS. 2 and 3 show a first example embodiment of the heating module 14, wherein FIG. 2 shows a section through the heating module 14 along the neighbour direction 20, and FIG. 3 shows a section through the in FIG. 2 one plane funning transversely to the section plane of FIG. 2, in such a way that only one of the heat transfer bodies 16 is visible. Accordingly, the heating module 14 of FIGS. 2 and 3 has four cold conductor elements 2, which are arranged adjacent to one another in neighbour direction 20. The cold conductor elements 2 are advantageously formed identically. In neighbour direction 20, the heating element 15 follows the cold conductor elements 2. As can be seen from FIGS. 2 and 3, the neighbour direction 20 runs parallel to a longitudinal direction 25 and transversely to a transverse direction 24 of the heating module 14. As can be seen in particular from FIG. 3, the heating module 14 has, furthermore, four electrical connections 26. Two of the electrical connections 26, designated below as first electrical connection 26′ and second electrical connection 26″, are connected via at least one electrical line 29 with the cold conductor elements 2 in such a way that the cold conductor elements 2 are connected in series via the at least one line 29. The two other electrical connections 26, designated below as third electrical connection 26′″ and fourth electrical connection 26″″, are electrically connected with the heating element 15 via two electrical lines 29 for the electrical supply of the heating element 15. The cold conductor elements 2 on the one hand and the heating element 15 on the other hand are able to be electrically connected in parallel via the electrical connections 26.

FIG. 4 shows an equivalent circuit diagram of the heating module 14, wherein in the equivalent circuit diagram 27 the cold conductor elements 2 are combined to a common cold conductor element 2. It can be seen from FIG. 4 that the cold conductor elements 2 and the heating element 15 are electrically connected in parallel. In FIG. 4 furthermore an equivalent resistance 28 of the electrical lines 29 is taken into consideration.

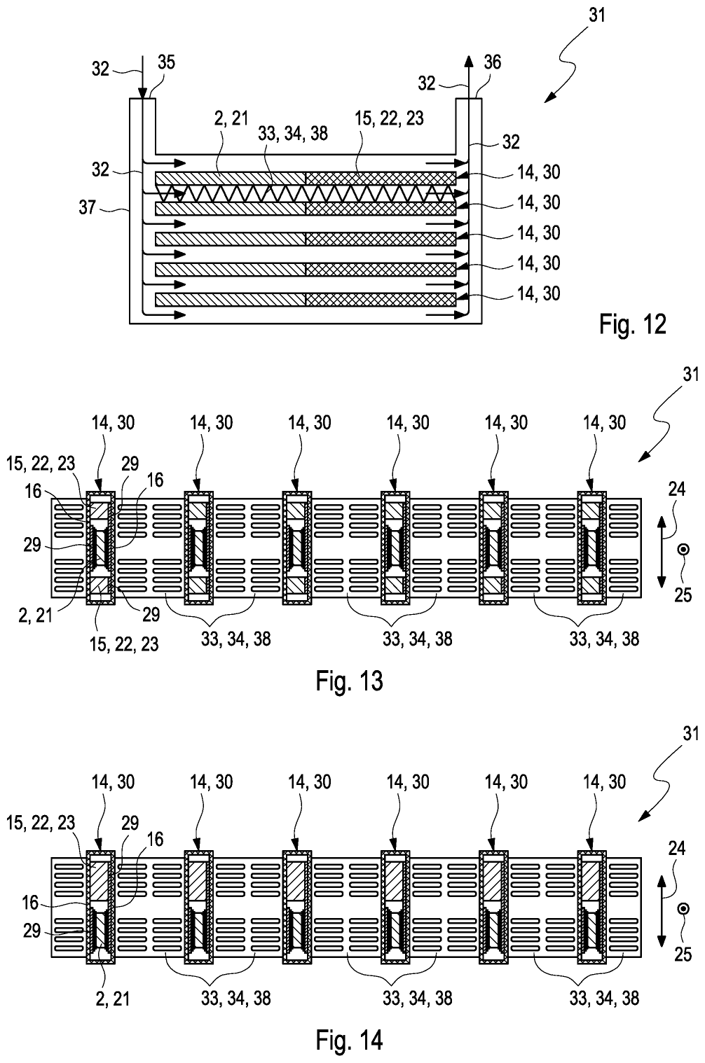

The heating module 14 is used in a heating device 31, the equivalent circuit diagram 27 of which is illustrated in FIG. 5 and which is illustrated by way of example in FIGS. 12 to 14.

FIG. 12 shows here a highly simplified illustration of the heating device 31 in section. As can be seen in particular from FIG. 12, the heating device 31 can serve for heating a fluid. For this purpose, a flow path 32 of the fluid, indicated by arrows, leads through the heating device 31. The heating device 31 has furthermore at least one heating module 14, which is connected with the flow path 32 in a heat-transferring manner, so that the heating module 14 heats the fluid in operation. In the example embodiment of FIG. 12, several such heating modules 14 are provided, which are arranged spaced apart with respect to one another. Here, the heating modules 14 are arranged respectively in the flow path 32, in such a way that the flow path 32 runs between the successive heating modules 14. Between the adjacent heating modules 14, as shown by way of example for two of the heating modules 14 in FIG. 12, a structure 33, in particular a rib structure 34 or a grid 38, can be arranged, which is able to be flowed through by the fluid, through which therefore the flow path 32 leads and by which the heat-transferring area as a whole is enlarged. As can be seen furthermore from FIG. 12, the respective heating device 31 can have an inlet 35 for letting in the fluid into the heating device 31, and an outlet 36 for letting out the fluid from the heating device 31. The respective heating device 31 can have, furthermore, a housing 37, in which the heating modules 14 are arranged and through which the flow path 32 leads. In the example embodiment of FIG. 12, for better illustration only one single cold conductor element 2 and the heating element 15 are illustrated. The direct contact between the cold conductor element 2 and the heating element 15 is in addition to symbolise the thermally heat-transferring connection of the heating element 15 with the respective cold conductor element 2. For this reason, the heat transfer bodies 16 are not illustrated in FIG. 12.

As can be seen from FIG. 5, the heating device 31 has, in addition to the heating module 14 with the heating element 15 and the at least one cold conductor element 2 which according to the equivalent circuit diagram 27 are connected or respectively able to be connected electrically in parallel, a switching device 39 by which the electrical supply of the heating element 15 and of the cold conductor element 2 can be respectively optionally disconnected or produced. In particular, the switching device 39 is configured in such a way that the electrical supply can be varied respectively. In the equivalent circuit diagram 27 of FIG. 5, the switching device 39 is realized by a first switch 40 and a second switch 41. For example, in a heating module 14 according to the example embodiment of FIGS. 2 and 3, the first switch 40 is able to connect the first electrical connection 26′ with the second electrical connection 26″, in order to supply the cold conductor elements 2 electrically and to disconnect this connection in order to interrupt an electrical supply of the cold conductor elements 2. In an analogous manner hereto, the second switch 41 is able to electrically connect the third electrical connection 26′″ with the fourth electrical connection 26″″, in order to supply the heating element 15 electrically and to disconnect this electrical connection in order to interrupt the electrical supply of the heating element 15. The heating device 31 has, in addition, a determining device 42. With the determining device 42, at least one value is determined which characterizes the temperature at least of one of the elements 2, 15, i.e. at least one of the cold conductor elements 2 and/or of the heating element 15. The determining device 42 determines, for this, in particular the temperature at least of one of the elements 2, 15 and/or the electrical resistance at least of one of the cold conductor elements 2 and/or the heating output of the heating module 14. The heating device 31 has, moreover, a control device 43 which, as indicated by dashed lines, is connected with the determining device 42 and with the switching device 39, in particular with the respective switch 40, 41, and serves for operating the heating device 31. Here, the switching device 39, the determining device 42 and the control device 43 are illustrated respectively only in FIG. 5.

A further example embodiment of the heating module 14 is shown in FIGS. 6 to 8. Here, FIG. 6 shows a section through the heating module 14 along the longitudinal direction 25. FIGS. 7 and 8 show sections through the section plane illustrated in dashed lines in FIG. 6, wherein FIG. 7 shows the section in the direction of one of the heat transfer bodies 16, also designated below as first heat transfer body 16′, and FIG. 8 shows the section in the direction of the other heat transfer body 16, also designated below as second heat transfer body 16″. In this example embodiment, the heating module 14, which is also formed as a heating rod 30, has five cold conductor elements 2 and ten heating elements 15. The heating elements 15 are formed respectively in a web-shaped manner and as a resistance heater 23, wherein also a configuration as a thick film heater 22 is conceivable. The cold conductor elements 2 are arranged spaced apart with respect to one another in longitudinal direction 25 and lie against both heat transfer bodies 16. Between the adjacent cold conductor elements 2, two heating elements 15 are arranged respectively lying opposite, spaced apart with respect to the cold conductor elements 2 and transversely to the longitudinal direction 25 and transversely to the transverse direction 24, wherein one of these heat conductor elements 15 lies in a planar manner against the first heat transfer body 16′, and the opposite heating element 15 lies in a planar manner against the second heat transfer body 16″. Respectively a heating element 15 adjoins the outer cold conductor elements 2 in longitudinal direction 25, spaced apart in longitudinal direction 25 with respect to the outer cold conductor elements 2, wherein one of these heating elements 15 lies in a planar manner against the first heat transfer body 16″ and the other heating element 15 lies in a planar manner against the second heat transfer body 16″. The heating elements 15 lying against the first heat transfer body 16′ are also designated below as first heating elements 15′. The heating elements 15 lying against the second heat transfer body 16″ are also designated below as second heating elements 15″. The heating module has here four electrical connections 26. A first electrical connection 26′ and a second electrical connection 26″ are mounted on the first heat transfer body 16′, wherein the first electrical connection 26′ serves for the electrical supply of the cold conductor elements 2 and the heating elements 15 lying against the first heat transfer body 16′, for example a connection of the cold conductor elements 2 and the said heating elements 15 at a first pole, in particular a minus pole, of a voltage source. The second electrical connection 26″ serves for the electrical supply of the first heating elements 15′ with a second other pole, for example the plus pole, of the voltage source. For this purpose, the first electrical connection 26′ is electrically connected via electrical lines 29 both with the cold conductor elements 2 and also with the first heating elements 15′. By comparison, the second electrical connection 26″ is connected via electrical lines 29 exclusively with the first heating elements 15′. A third electrical connection 26′″ and a fourth electrical connection 26″″ are mounted on the second heat transfer body 16″. The third electrical connection 26′″ serves for the electrical supply of the cold conductor elements 2 and second heating elements 15″ with the second pole of the voltage source, therefore for example the plus pole. Accordingly, the third electrical connection 26′″ is connected via electrical lines 29 with the cold conductor elements 2 and the second heating elements 15″. The fourth electrical connection 26″″ serves for the electrical supply of the second heating elements 15″ with the first pole of the voltage source, therefore for example the minus pole. Accordingly, the fourth electrical connection 26″″ is electrically connected via electrical lines 29 exclusively with the second heating elements 15″. Therefore, the heating module 14 shown in FIGS. 6 to 8 can be operated and electrically supplied more variably. In particular, the first heating elements 15′ and the second heating elements 15″ can be electrically supplied separately and individually. In addition, therefore, the first heating elements 15′ are connected in series and connected in parallel to the cold conductor elements 2. Furthermore, the second heating elements 15″ are connected in series and connected in parallel to the cold conductor elements 2. Furthermore, in this way, the cold conductor elements 2 are connected in series.

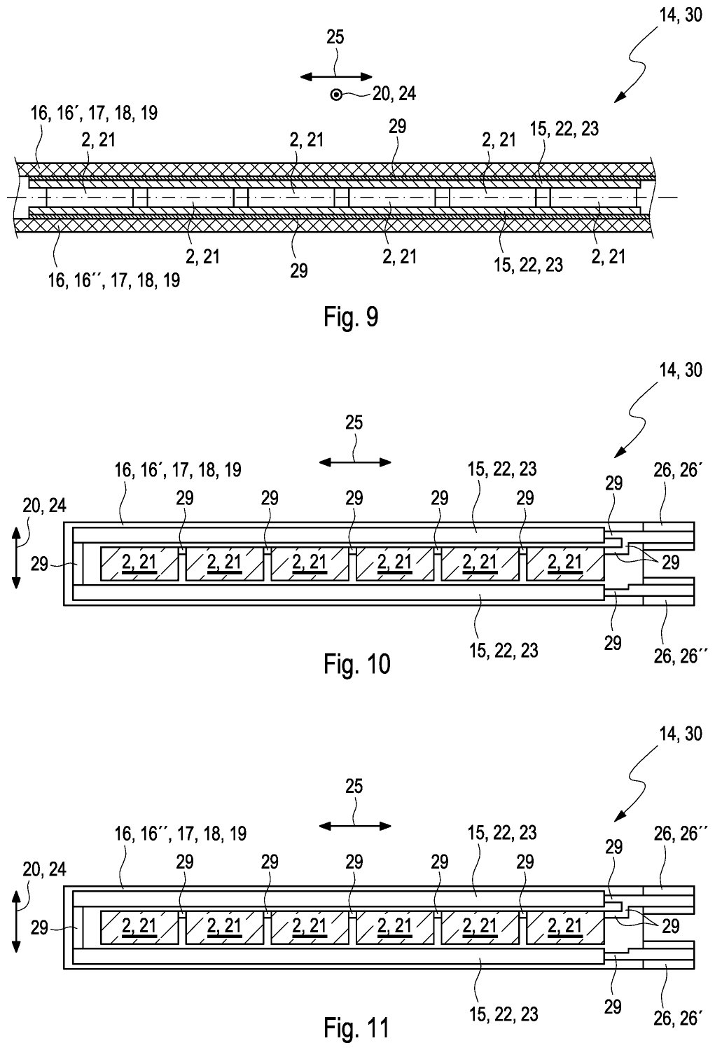

FIGS. 9 to 11 show another example embodiment of the heating module 14. Here, FIG. 9 shows a section through the heating module 14 along the longitudinal direction 25. FIGS. 10 and 11 show sections through the heating module 14 along the plane illustrated in dashed lines in FIG. 9, wherein FIG. 10 shows the section in the direction of a first of the heat transfer bodies 16, also designated below as first heat transfer body 16′, and FIG. 11 shows the section in the direction of the other heat transfer body 16, also designated below as second heat transfer body 16″. In this example embodiment, the neighbour direction 20 runs parallel to the transverse direction 24, corresponds in particular to the transverse direction 24. The heating module 14 shown in FIGS. 9 to 11 is accordingly also formed as a heating rod 30 and has a total of six cold conductor elements 2, which are formed as cold conductor blocks 21 and are arranged in longitudinal direction 25 adjacent to one another and in transverse direction 24 centrally to the heat transfer bodies 16. The heating module 14 shown in FIGS. 9 to 11 has, in addition, two heating elements 15 which are respectively spaced apart with respect to the cold conductor elements 2. The heating elements 15 are arranged lying opposite in transverse direction 24, in such a way that the cold conductor elements 2 are arranged in transverse direction 24 between the heating elements 15. The respective heating element 15 can be a web-shaped resistance heater 23 or a web-shaped thick film heater 22. The heating module 14 has, in addition, two electrical connections 26, which are only shown in FIGS. 10 and 11. The heating elements 15 are connected with one another via an electrical line 29. In addition, one of the heating elements 15 is connected with a first of the electrical connections 26′, and the other heating element 15 is connected with the second electrical connection 26″ via electrical lines 29, so that the heating elements 15 are connected in series. The cold conductor elements 2 are connected with one another via electrical lines 29. In addition, one of the cold conductor elements 2 is connected via electrical lines 29 with the first electrical connection 26′ and with the second electrical connection 26″, so that the cold conductor elements 2 are connected in series and so that the cold conductor elements 2 and the heating elements 15 are connected in parallel.

FIG. 13 shows a section through the heating device 31 in another example embodiment. This example embodiment differs from the example embodiment shown in FIG. 12 in particular in that the heating device 31 has six heating modules 14. Here, between the adjacent heating modules 14 which are arranged spaced apart from one another, structures 33, in particular a rib structure 34 or respectively a grid 38, are arranged. As can be seen from FIG. 13, the heating modules 14 are respectively formed identically, wherein the heating modules 14 in FIG. 13 correspond purely by way of example respectively to the heating module 14 of FIGS. 9 to 11. In this example embodiment, the flow path 32 runs along the longitudinal direction 25 between the heating modules 14.

A further example embodiment of the heating device 31 is shown in FIG. 14. This example embodiment differs from the example embodiment shown in FIG. 13 in that different heating modules 14 are provided. The heating modules 14 shown in FIG. 14 differ from the heating modules 14 shown in FIG. 13 in that the respective heating module 14 has only one heating element 15, which in particular can be web-shaped, which is spaced apart with respect to the cold conductor elements 2 in transverse direction 24.

The cold conductor elements 2 of the respective heating module 14 provide, in operation, a heating output which is also designated below as cold conductor heating output. The heating output, provided in operation, of the at least one heating element 15 is also designated below as heating element heating output, and the total heating output of the heating module 14 is also designated below as total heating output.

The heating modules 14 are preferably configured in such a way that a maximally available cold conductor heating output of the cold conductor elements 2 corresponds to between 80% and 95% of the maximum total heating output of the heating module 14. In addition, a maximum heating output of the at least one heating element 15 is at least as great as the difference between the maximum total heating output and the maximum cold conductor heating output.

The respective heating device 31 can be operated as follows with the aid of the control device 43, the determining device 42 and the switching device 39.

When the temperature at least of one of the at least one cold conductor elements 2 of one of the heating modules 14 lies below the starting temperature 5 of the cold conductor element 2, then the heating device 31 is operated in a starting operation. The taking into consideration of the temperature of the cold conductor element 2 takes place here with the aid of the determining device 42. In the starting operation, an electrical supply of the at least one cold conductor element 2 of the heating module 14 is interrupted, so that the cold conductor element 2 is not flowed through by an electrical current. By comparison, the at least one heating element 15 of the heating module 14 is supplied electrically. The electrical supply or respectively the interruption of the electrical supply of the respective element 2, 15 takes place here by the switching device 39. Therefore, in the starting operation, firstly exclusively heat is generated with the at least one heating element 15. Through the heat-transferring connection of the at least one heating element 15 with the at least one cold conductor element 2, therefore the temperature of the cold conductor element 2 also rises. When the temperature of the at least one cold conductor element 2 exceeds the starting temperature 5 of the cold conductor element 2, the cold conductor element 2 is also supplied electrically. Therefore, the NTC range 7 of the cold conductor element 2 and the transition between the NTC range 7 and the PTC range 12, in which electrical current peaks and voltage peaks can occur, is jumped over. When the at least one cold conductor element 2 is electrically supplied, then the cold conductor element 2 also generates heat and therefore contributes at least to the total heating output of the heating module 14. With the electrical supply of the at least one cold conductor element 2 on reaching or respectively exceeding the starting temperature 5 of the cold conductor element 2, the operation of the heating module 14 passes into a regular operation.

Within a possible regular operation, also designated below as first regular operation, the electrical output which is fed to the at least one heating element 15 can be reduced here and therefore also can be interrupted, when a maximum operating temperature of the heating module 14 is reached. The maximum operating temperature of the heating module 14 is predetermined here. The maximum operating temperature can correspond here in particular to the end temperature 10 of the at least one cold conductor element 2.

Alternatively it is possible, in the starting operation with the electrical supplying of the at least one cold conductor element 2, to interrupt the electrical supplying of the at least one heating element 15. This means that in the subsequent regular operation, the total heating output of the heating module 14 is provided exclusively through the at least one cold conductor element 2. This takes place within an alternative regular operation, also designated below as second regular operation. In the second regular operation, the required total heating output to the heating module 14 is provided exclusively with the at least one cold conductor element 2, i.e. in particular without the at least one heating element 15. This takes place until the required total heating output exceeds the maximum heating output of the at least one cold conductor element 2 and therefore the maximum cold conductor heating output. In this case, also at least one of the at least one heating elements 15 is supplied electrically, in order to provide the difference between the maximum cold conductor heating output and the required total heating output.

Of course, the heating device 31 can be operated in the starting operation, when the temperature at least of one of the at least one cold conductor elements 2 of the heating module 14 falls below the starting temperature 5 of the cold conductor element 2.

In the respective heating device 31, the respective heating module 14 can be operated individually in the manner described above. It is also conceivable to operate at least two of the heating modules 14 of the heating device 31 through a corresponding interconnection jointly in the manner described above.

1. A heating module, comprising:
at least one cold conductor element and at least one electrical heating element that is different from the at least one cold conductor element,
the at least one cold conductor element and the at least one heating element are electrically connectable in parallel, and
the at least one cold conductor element and the at least one heating element are connected with one another thermally in a heat-transferring manner.

2. The heating module according to claim 1, wherein:
a maximum operating temperature is predetermined, and
the at least one cold conductor element is configured such that the maximum operating temperature lies above a starting temperature of the at least one cold conductor element.

3. The heating module according to claim 2, wherein the at least one cold conductor element is configured such that the maximum operating temperature is equal to or greater than an end temperature of the at least one cold conductor element.

4. The heating module according to claim 1, wherein an electrical resistance of the at least one heating element and a nominal resistance of the at least one cold conductor element are in a ratio of between 95:5 to 5:95.

5. The heating module according to claim 4, wherein the electrical resistance of the at least one heating element and the nominal resistance of the at least one cold conductor element are in a ratio of between 30:70 to 70:30.

6. The heating module according to claim 1, further comprising at least one heat transfer body, separate from the at least one cold conductor element and from the at least one heating element, wherein the at least one heat transfer body is connected in a planar, heat-transferring manner with the at least one cold conductor element and the at least one heating element and connects the at least one cold conductor element and the at least one heating element thermally with one another.

7. The heating module according to claim 6, wherein the at least one heat transfer body is structured as a plate.

8. The heating module according to claim 6, wherein the at least one heat transfer body is a ceramic.

9. The heating module according to claim 1, wherein:
the at least one cold conductor element and the at least one heating element are arranged adjacent to one another in a neighbour direction,
further including at least one electrically insulating plate arranged transversely to the neighbour direction adjacent at least to the at least one cold conductor element and the at least one heating element, and connects the at least one cold conductor element and the at least one heating element with one another thermally in a heat-transferring manner.

10. The heating module according to claim 1, wherein:
the heating module has a maximum total heating output,
the at least one cold conductor element is configured such that a maximum cold conductor heating output of the at least one cold conductor element corresponds to between 80% and 95% of the maximum total heating output, and
the at least one heating element is configured such that a maximum heating element heating output of the at least one heating element corresponds at least to the difference between the maximum total heating output and the maximum cold conductor heating output.

11. A heating device, comprising:
a heating module, the heating module including:
at least one cold conductor element and at least one electrical heating element that is different from the at least one cold conductor element,
the at least one cold conductor element and the at least one heating element are electrically connectable in parallel,
the at least one cold conductor element and the at least one heating element are connected with one another thermally in a heat-transferring manner,
a switching device configured such that, in operation, it respectively produces and disconnects an electrical supply at least of the at least one cold conductor element and the at least one heating element,
a determining device configured such that, in operation, it determines at least one value characterizing a temperature of at least one of the at least one cold conductor element and the at least one heating element, and
a control device connected with the switching device and with the determining device in a communicating manner and configured for operating the heating device.

12. The heating device according to claim 11, wherein the control device is configured such that, in a starting operation where the temperature of the at least one cold conductor element lies below a starting temperature of the at least one cold conductor element, the control device operates the heating device as follows:
the electrical supply of the at least one cold conductor element is interrupted and the at least one heating element is supplied electrically, so that the at least one heating element generates heat, and
the at least one cold conductor element is supplied electrically, when the at least one value corresponds to a temperature of the at least one cold conductor element that is greater than or equal to the starting temperature of the at least one cold conductor element.

13. The heating device according to claim 12, wherein the control device is configured such that it furthermore operates the heating device in the starting operation as follows:
the electrical supply of the at least one heating element is interrupted when the at least one value corresponds to a temperature of the at least one cold conductor element that is greater than or equal to the starting temperature.

14. The heating device according to claim 11, wherein the control device is configured such that, in a first regular operation where the temperature of the at least one cold conductor element lies above the starting temperature of the at least one cold conductor element, the control device operates the heating device as follows:
the at least one value characterizing the temperature of the at least one of the at least one cold conducting element and the at least one heating element is monitored, and
an electrical output that is fed to the at least one heating element is reduced when the at least one value corresponds to a predetermined maximum operating temperature of the heating module.

15. The heating device according to claim 13, wherein the control device is configured such that, in a second regular operation where the temperature of the at least one cold conductor element lies above the starting temperature of the at least one cold conductor element, the control device operates the heating device as follows:
when a required total heating output is less than or equal to a maximum cold conductor heating output, exclusively the at least one cold conductor element is supplied electrically, and
when a required total heating capacity rises above the maximum cold conductor heating output, in addition the at least one heating element is supplied electrically.

16. The heating device according to claim 11, wherein the determining device is configured such that it determines, as the at least one value, the temperature of the at least one of the at least one cold conductor element and the at least one heating element.

17. The heating device according to claim 11, wherein the determining device is configured such that it determines, as the at least one value, an electrical resistance of the at least one cold conductor element.

18. The heating device according to claim 11, wherein the determining device is configured such that it determines, as the at least one value, a heating output of the heating module.

19. The heating device according to claim 11, further comprising a flow path of a fluid that leads through the heating device, and the heating module is connected with the flow path in a heat-transferring manner.

20. The heating device according to claim 11, wherein an electrical resistance of the at least one heating element and a nominal resistance of the at least one cold conductor element are in a ratio of between 95:5 to 5:95.
